(19) United States
(12) Patent Application Publication
(10) Pub. No.: US 2020/0306119 A1
(43) Pub. Date: Oct. 1, 2020

(54) SPINAL TRACTION DEVICE

(71) Applicant: University of Utah Research Foundation, Salt Lake City, UT (US)

(72) Inventors: Timothy Henry, Salt Lake City, UT (US); Daivd Carter, Salt Lake City, UT (US); Daniel Pendleton, Salt Lake City, UT (US); David Bennett, Salt Lake City, UT (US)

(21) Appl. No.: 16/088,009

(22) PCT Filed: Mar. 23, 2017
(86) PCT No.: PCT/US2017/023852

§ 371 Date: Sep. 24, 2018

Related U.S. Application Data
(60) Provisional application No. 62/312,386, filed on Mar. 23, 2016.

(51) Int. Cl. A61H 1/02

(52) U.S. Cl. CPC A61H 1/0229; A61H 2201/0161; A61H 2201/0192; A61H 2203/0456; A61H 2201/1642; A61H 2201/1652; A61H 2201/1676; A61H 2201/163

(57) ABSTRACT

A spinal traction device (10) can include a harness (14) including a waist support panel (18) which is securable to a user proximate the user's hips. The spinal traction device (10) can also include first and second flexible tension members (16a, 16b) coupled to the harness (14). A support structure (12) includes stabilization legs (30a-c) and an upper support frame (24) which supports the first and second flexible tension members (16a, 16b) at a predetermined support height and further includes a harness height adjustment mechanism. The first and second flexible tension members (16a, 16b) can be supported by the support structure (12) at a spaced horizontal distance from one another, such that the harness height adjustment mechanism facilitates movement of the user's hips above the user's upper body such that at least a portion of the user's upper body weight serves to traction at least a portion of the user's spine. Other embodiments provide for support of a user's lower body and adjustability of the traction of the spine.

### RELATED APPLICATION(S)

This application claims priority to U.S. Provisional Application No. 62/312,386, filed Mar. 23, 2016, which is incorporated herein by reference.

### GOVERNMENT INTEREST

None.

### FIELD OF THE INVENTION

The present invention relates to back traction and physical therapy devices usable for assisting a user thereof to traction the user's spine. Accordingly, the invention relates generally to the fields of biomechanical engineering, physical therapy, and mechanical engineering.

### BACKGROUND

Lower back pain affects hundreds of millions of people with adverse effects ranging from minor discomfort to severe incapacitating pain. In many cases, lumbar traction has been used to treat this pain by stretching the spine so that pressure on compressed disks is reduced, allowing the body to heal and reducing discomfort. A variety of devices and methods have been developed to implement lumbar traction in clinics and in the home. Though there are clinically proven benefits of such treatment, the care and equipment needed can be costly, large, complicated, inconvenient, and in some cases ineffective. As such, additional options and improvements continue to be sought to improve the affordability, ease, and convenience of such treatments.

### SUMMARY

In one embodiment, a spinal traction device can include a harness having a waist support panel which is securable to a user proximate the user's hips. The spinal traction device can also include first and second flexible tension members coupled to the harness. In addition, the spinal traction device can have a support structure including stabilization legs and an upper support frame which supports the first and second flexible tension members at a predetermined support height and further includes a harness height adjustment mechanism. The first flexible tension member can extend from the harness on a left side of the user, the second flexible tension member can extend from the harness on a right side of the user, and the first and second flexible tension members can be supported by the support structure at a spaced horizontal distance from one another, such that the harness height adjustment mechanism facilitates movement of the user's hips above the user's upper body such that at least a portion of the user's upper body weight serves to traction at least a portion of the user's spine.

In another embodiment, a spinal traction device can include a support structure. The spinal traction device can also include a harness configured to be secured to a user proximate the user's hips. The spinal traction device can further include a flexible tension member coupled to the support structure and the harness, such that the user's hips are supported above the user's upper body and at least a portion of the user's upper body weight serves to traction at least a portion of the user's spine. In addition, the spinal traction device can include a lower extremity support member supported by the support structure for supporting a lower extremity of the user. The lower extremity support member can be translatable relative to the support structure to facilitate positioning the lower extremity support member relative to the user.

In yet another embodiment, a spinal traction device can include a harness configured to be secured to a user proximate the user's hips. The spinal traction device can also include a flexible tension member coupled to the harness. In addition, the spinal traction device can include a support structure configured to support the flexible tension member such that the user's hips are supported above the user's upper body and at least a portion of the user's upper body weight serves to traction at least a portion of the user's spine. The support structure can have a flexible tension member support configured to interface with the flexible tension member and facilitate movement of the flexible tension member relative to the flexible tension member support, a leg extending from the flexible tension member support, and a movable anchor associated with and movable relative to the leg. The movable anchor can be coupled to an end of the flexible tension member, such that movement of the movable anchor causes a vertical position of the harness to change thereby adjusting the traction of the spine.

The above embodiments illustrate several possible configurations of a spinal traction device in accordance with the present disclosure. Thus, it should be recognized that certain embodiments of a spinal traction device need not include any particular component or feature included in any other embodiment, and that a spinal traction device may be configured utilizing any suitable component or feature disclosed herein.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF DRAWINGS

FIG. 1 is an isometricview of a spinal traction device in an operational configuration and in-use by a patient in accordance with an example of the present disclosure.

FIG. 2 is an isometric view of a spinal traction device support structure of the spinal traction device in the operational configuration in accordance with an example of the present disclosure.

FIG. 3 is a front view of the spinal traction device of FIG. 1 in the operational configuration in accordance with an example of the present disclosure.

FIG. 4 is an isometric view of a movable anchor of the spinal traction device support structure of FIGS. 1-3 in accordance with an example of the present disclosure.

FIG. 5A is an isometric side view of the spinal traction device partially folded from the operational configuration to the storage configuration in accordance with an example of the present disclosure.

FIG. 5B is an isometric view of a rotational lock coupling of the spinal traction device in accordance with an example of the present disclosure.

FIG. 5C is an isometric view of the rotational lock coupling of FIG. 5B in accordance with an example of the present disclosure.

FIG. 5D is a top view of the spinal traction device in the storage configuration in accordance with an example of the present disclosure.

FIG. 5E is a side view of the spinal traction device in the storage configuration in accordance with an example of the present disclosure.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a flexible tension member” includes reference to one or more of such features and reference to “moving” refers to one or more such steps.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Measurements and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Accordingly, the scope of the invention should be determined solely by the appended claims and their legal equivalents, rather than by the descriptions and examples given herein.

Spinal Traction Device

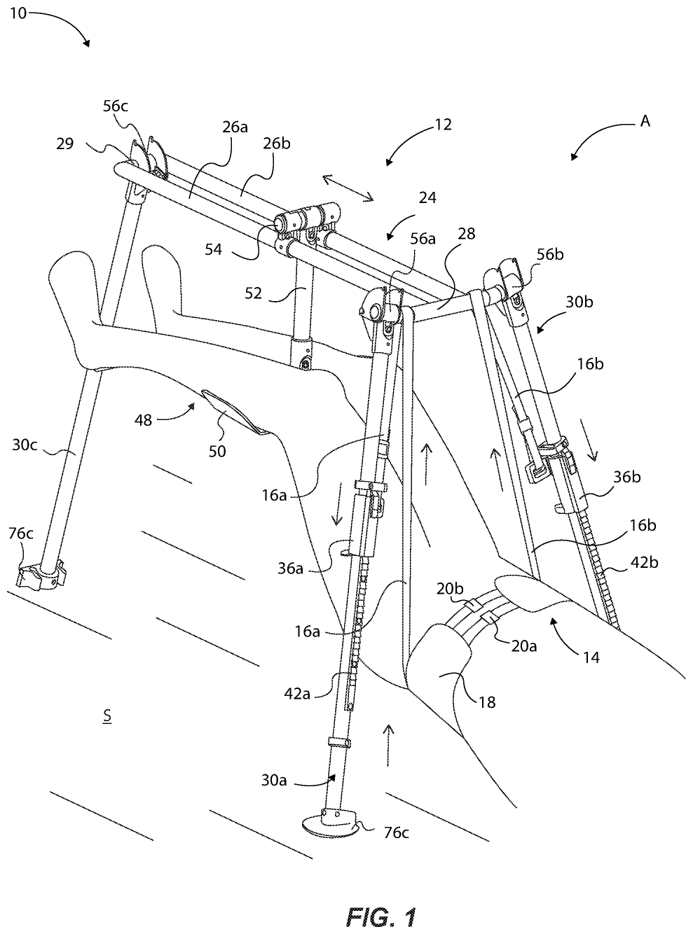

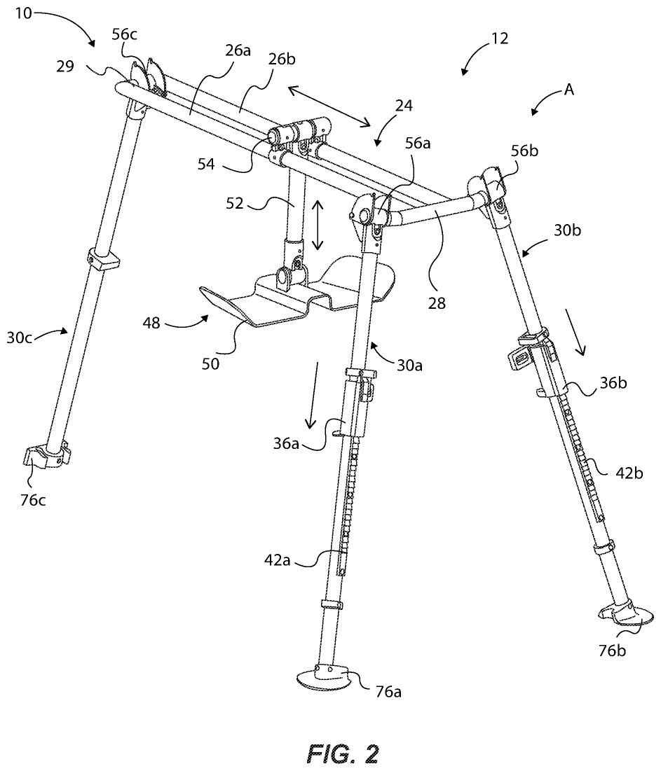

Referring generally to FIGS. 1-4, certain aspects of a spinal traction device 10 are illustrated in accordance with an example of the present disclosure. In particular, FIG. 1 shows the spinal traction device 10 in a deployed position A and in-use by a patient, and FIGS. 2-4 illustrate various views and elements of the spinal traction device 10, in accordance with some examples of the present disclosure.

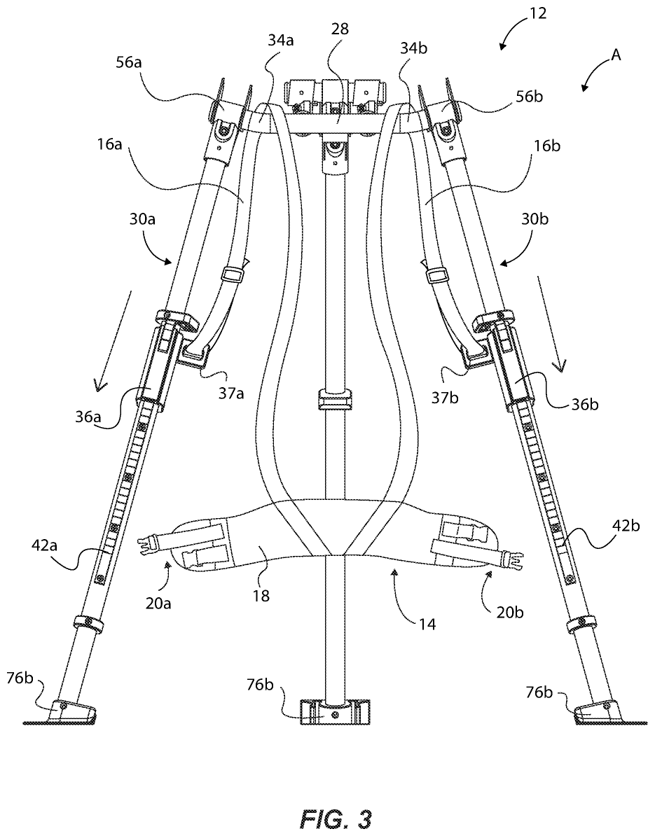

With particular reference to FIGS. 1-3, the spinal traction device 10 is shown in the deployed position A, and can include a support structure 12, a harness 14, and flexible tension members 16a and 16b (e.g., left and right woven belts, although one flexible tension member can be used in some examples). The harness 14 can include a waist support panel 18 that includes pairs of attachment members 20a and 20b extending from left and right sides of the waist support panel 18 (FIG. 3). Each pair of attachment members 20a and 20b can be plastic snap clips (e.g., male/female) that wrap around a front of the user's waist and snap together near the user's abdomen. Other attachment means are possible, such as hook and loop, buttons, etc.

The flexible tension members 16a and 16b can be attached to the harness 14 at an upper middle edge portion of the waist support panel 18 (FIG. 3). In this manner, as shown on FIG. 1 the flexible tension members 16a and 16b wrap around the back side of the user's hips (respectively) to provide evenly distributed tension or pressure around the user's waist.

The support structure 12 can be configured to support the flexible tension members 16a and 16b. For example, an upper support frame 24 can comprise a pair of parallel frame members 26a and 26b that each extend generally longitudinally relative to the user's spine. Thus, the parallel frame members 26a and 26b can generally intersect the sagittal plane of the user (although a single frame member can be used).

The upper support frame 24 can comprise a flexible tension member support 28 rigidly attached to the parallel frame members 26a and 26b. The stabilization legs can include at least three legs 30a, 30b, and 30c in support of the upper support frame 24. The upper support frame 24 and the legs can be comprised of a rigid material, such as steel or aluminum.

More specifically, left and right legs 30a and 30b can be attached (e.g., rigidly or pivotally) to ends of the flexible tension member support 28. Similarly, a rear leg 30c can be attached (e.g., rigidly or pivotally) to a rear frame member 29 coupling the parallel frame member 26a and 26b. The left and right legs 30a and 30b can be configured to be located on left and right sides of the user, as shown in FIG. 1. The left and right legs 30a and 30b can be slanted or angled outward to provide stability for the device while in use. Typically, the left and right legs 30a and 30b can be angled outward at an angle from about 5° to about 25° relative to a horizontal plane, although other angles may be suitable. Although three legs are illustrated in support of the upper support frame 24, it should be recognized that any suitable number of legs can be included and arranged in any suitable configuration to facilitate use and operation of the spinal traction device 10 as disclosed herein. In one example, only two front legs can be used and the rear of the support frame can be fastened to a wall or other support structure.

With reference to FIGS. 1-4, the spinal traction device 10 comprises a harness height adjustment mechanism that can facilitate movement of the user's hips above the user's upper body such that at least a portion of the user's upper body weight serves to traction at least a portion of the user's spine.

More specifically, the flexible tension member support 28 can support each of the flexible tension members 16a and 16b at a spaced horizontal distance from each other. That is, each flexible tension member 16a and 16b can be wrapped over the top of the flexible tension member support 28 and spaced apart from each other (e.g., FIG. 3). In one aspect, the horizontal spacing of the flexible tension members 16a and 16b can facilitate a height reduction of the support frame 12 (compared to a common or single flexible tension member support configuration).

In some examples, an end of each flexible tension member 16a and 16b is coupled to a respective movable anchor 36a and 36b such that the flexible tension members 16a and 16b extend upwardly from the waist panel 18, then are wrapped around/over the flexible tension member support 28, and then extend downwardly and attached to the respective movable anchor 36a and 36b (FIG. 3). As further discussed below, the harness height adjustment mechanism facilitates raising and lowering the user's waist. Typically, the user will have some portion of the user's upper body (e.g., shoulders/back) supported by an underlying support surface S (e.g. floor matt, floor, or ground surface). The harness height adjustment mechanism can position the harness 14, and consequently the user's hips, with respect to the underlying support surface S so as to adjust a raised distance between the support surface S and the harness 14 or hips of the user. As a result, vertebrae and muscles of the lower back are placed in tension. Unlike conventional inversion traction devices, tension forces result from only a portion of the user's body and the lifting force from the device rather than weight from an entire torso and upper body. Accordingly, excessive tension and traction forces can be more easily avoided.

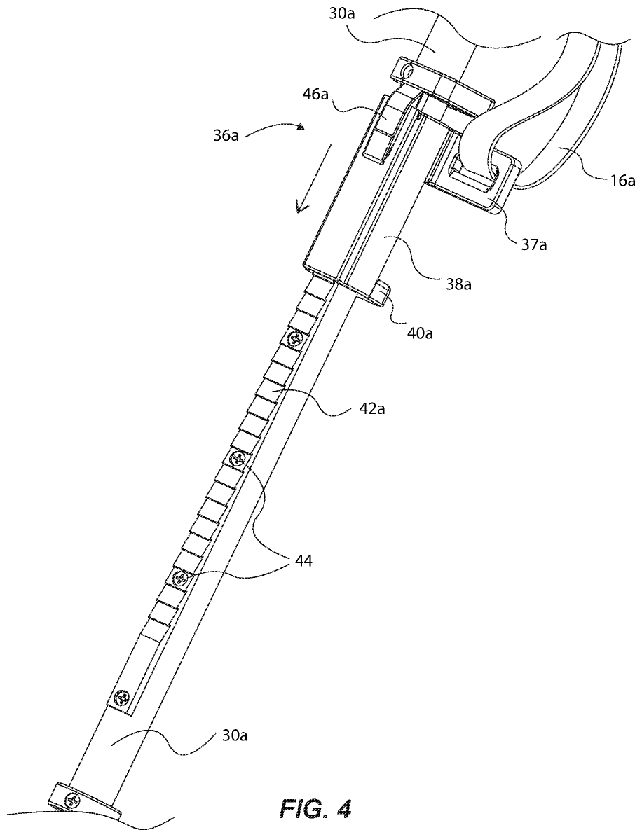

With particular reference to FIGS. 3 and 4, the flexible tension member support 28 can include respective flexible tension member support portions 34a and 34b (FIG. 3) to interface with and support the respective flexible tension members 16a and 16b. Thus, the flexible tension members 16a and 16b are spaced apart at a horizontal distance from one another about the flexible tension member support 28. As best shown on FIG. 3, the flexible tension members 16a and 16b can be wrapped or routed over a top of the flexible tension member support 28 about the flexible tension member support portions 34a and 34b. Optional strap guides (not shown) can align movement of flexible tension members 16a and 16b.

Relative horizontal spacing between the flexible tension members 16a and 16b can be maintained by physical barriers associated with the flexible tension member support 28. For example, the parallel frame members 26a and 26b can provide a mechanical limit to inward movement of the flexible tension members 16a and 16b where the parallel frame members 26a and 26b extend from the flexible tension member support 28. The flexible tension member support 28 can also be configured to inhibit excessive outward movement of the flexible tension members 16a and 16b, which may result in one or both of the flexible tension members 16a and 16b becoming disengaged with the flexible tension member support (e.g., falling off an outer end of the flexible tension member support). Such unwanted outward movement of the flexible tension members 16a and 16b can be mechanically prevented or inhibited by respective upwardly angled surfaces (e.g., 34a and 34b of FIG. 3) of the flexible tension member support 28, which can serve to maintain the flexible tension members 16a and 16b in a desired region or zone relative to the flexible tension member support 28 and maintain the horizontal distance between the flexible tension members 16a and 16b. It should be recognized that any suitable structure or mechanism can be utilized to facilitate movement of the flexible tension members 16a and 16b relative to the flexible tension member support 28, such as a pulley, wheel, roller, bearing, low-friction surface, etc.

In one aspect, the height adjustment mechanism can include a user manipulable adjustment. For example, the movable anchors 36a and 36b can be associated with and movable (e.g., slidable or translatable) relative to respective legs 30a and 30b. The movable anchors 36a and 36b can be coupled to ends of the flexible tension members 16a and 16b (as best illustrated in the detailed view of FIG. 4) via respective coupling members 37a and 37b, such that movement of the movable anchors 36a and 36b causes a vertical position of the harness 14 to change, thereby adjusting the traction of the user's spine. For the position of the anchors 36a and 36b shown on FIGS. 1-4, moving the anchors 36a and 36b in a downward direction (see associated arrows) will raise the harness 14 (FIG. 1) and increase traction. Thus, moving the anchors 36a and 36b in an upward direction will lower the harness 14 and decrease traction.

The coupling members 37a and 37b can be any suitable mechanism for coupling the flexible tension members 16a and 16b to respective anchors 36a and 36b, such as an aperture (as best shown on FIG. 4), or a hook, ring, etc. As shown in the illustrated example of FIG. 4, the flexible tension member 16a can be looped through the aperture of the coupling member 37a and the attached (e.g., removably secured) to itself by a clip or other mechanism.

The movable anchors 36a and 36b can be configured for grasping by the user to facilitate user adjustability of the spinal traction. Accordingly, the movable anchors 36a and 36b can be disposed along the respective legs 30a and 30b at locations (e.g., 1-2 feet off the surface S) that facilitate grasping by the user when engaged with or using the spinal traction device 10. In addition, the movable anchors 36a and 36b can each include a handle portion 38a and 38b configured to enhance the user's grip, such as with friction enhancing features and/or a lip 40a (FIG. 4) to mechanically inhibit sliding of the user's hand off the handle portion 38a, for example. The lip 40a can be located at a bottom end of the handle portion 38a to prevent the user's hand from sliding off while causing downward movement of the movable anchor 36a, since this direction will have the most resistance in the illustrated configuration due to lifting a portion of the user's weight.

The harness height adjustment mechanism can also include a locking mechanism associated with the anchor 36a, for instance. As shown in the detail view of FIG. 4, the locking mechanism can include a locking bar 42a having a plurality of teeth and fastened to the leg 30a by fasteners 44. The teeth can be downward facing teeth configured to resist upward movement of the anchor 36a (i.e., from the upward pulling force due to the weight of the user). Further, the locking mechanism can comprise a pawl 46a configured to engage the teeth of the locking bar 42a, which prevents movement of the movable anchor 36a in an upward direction along the leg 30a when the pawl 46a is locked. The pawl 46a can be spring-loaded to cause automatic engagement with the teeth of the locking bar 42a. Specifically, the user can disengage the pawl 46a (e.g., with a thumb) to disengage the pawl 46a from a tooth of the locking bar 42a to allow the movable anchor 36a to move upwardly or downwardly along the leg 30a, thus vertically lowering or raising the harness 14 and modifying the degree of spinal traction. With the ability to adjust the spinal traction device 10 while using the device, an individual can operate the device alone and without the aid of others.

It can be desirable to support a lower portion of a user's leg (e.g. a calf region) to provide comfort for the user, and to maintain a desired hip position during traction. Therefore, in one embodiment, the spinal traction device 10 can include a lower extremity support member 48 extending below and supported by the parallel frame members 26a and 26b for supporting a lower extremity of the user (FIGS. 1 and 2). For example, the lower extremity support member 48 can include a calf support platform 50 having a left calf rest and a right calf rest (FIG. 2) configured to support left and right calves of the user (FIG. 1), respectively. The lower extremity support member 48 can comprise an adjustable support member 52 pivotally coupled at one end to the calf support platform 50 and pivotally) attached the pair of parallel frame members 26a and 26b by a mounting mechanism 54. The mounting mechanism 54 can include various brackets and round-bar coupling components (not labeled for illustration clarity) that slidably (horizontally) couples the lower extremity support member 48 to the parallel frame members 26a and 26b (as shown by the associated arrows), which provides translation of the calf support platform 50 to accommodate different size users. In this case, the parallel frame members 26a and 26b can be configured as a rail and the lower extremity support member 48 can be movable or slidable along the rail, such as utilizing a wheel, roller, bearing, low-friction surface, etc.

The adjustable support member 52 can also include a height adjustment mechanism for vertical adjustment, such as by utilizing a pin and hole mechanism (not shown) that allows telescopic movement of the calf support platform 50 relative to the parallel frame members 26a and 26b. Locking detents can also be used to facilitate such vertical adjustment. Other mechanisms can be used to support the user's calves, such as adjustable straps and harnesses that are adjustable vertically and horizontally relative to the parallel frame members 26a and 26b.

Thus, during use of the spinal traction device 10, a user can lay on the support surface S with hips elevated by the waist panel 14 and with calves resting on the calf support platform 50. As discussed above, the flexible tension member support 28, which interfaces with the flexible tension members 16a and 16b, can be configured to facilitate movement of the flexible tension members 16a and 16b relative to the flexible tension member support 28. Such movement of the flexible tension members 16a and 16b can cause a vertical position of the harness 14 to change, thereby adjusting the traction of the user's spine.

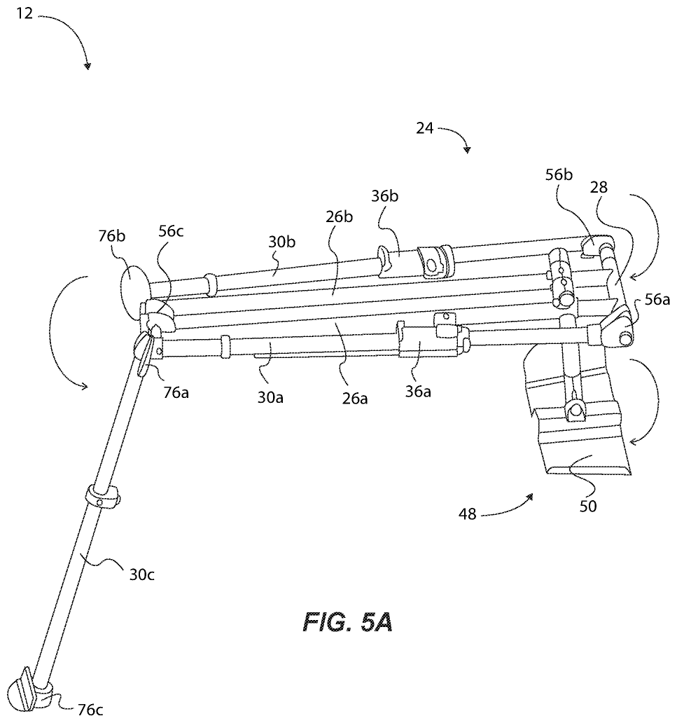

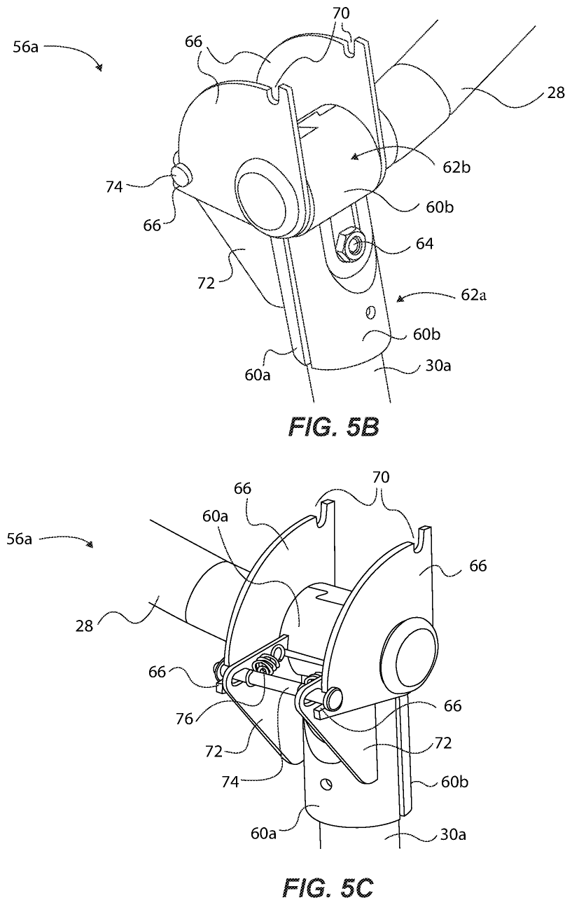

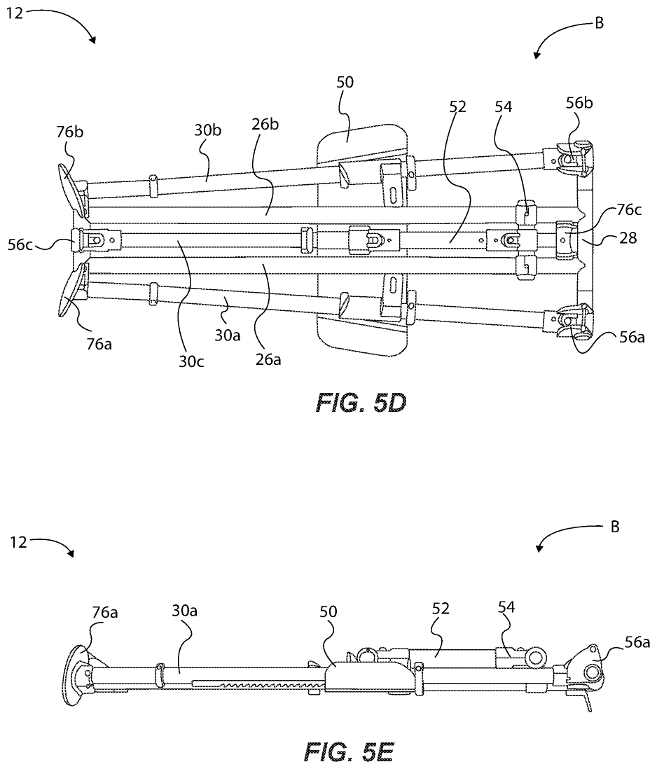

In one aspect, illustrated in FIGS. 5A-5E, the support structure 12 can be configured for ease of storage and/or transport. In this case, the support structure 12 can be collapsible with the legs 30a-c folded inward and, along with the lower extremity support member 48, folded flat into a storage configuration B (see FIGS. 5D and 5E). More specifically, and with reference to FIG. 5A, each leg 30a-c can be rotatably coupled to the upper support frame 24 by respective rotational lock couplings 56a-c. Each rotational lock coupling 56a-c can be configured to lock when the support structure 12 is in the storage configuration B and/or when in the operational configuration A to prevent unwanted unfolding or folding of the legs 30a-c and/or the lower extremity support member 48.

FIGS. 5B and 5C show the rotational lock coupling 56a of the left leg 30a, for example, in the operational configuration. The rotational lock coupling 56a rotationally couples the flexible tension member support 28 to leg 30a. The rotational lock coupling 56a can comprise an inner clamp shell 60a and an outer clamp shell 60b that both clamp together to pivotally couple the leg 30a to the flexible tension member support 28. That is, once clamped together a lower circular coupling 62a is generated and is secured to the leg 30a by a fastener 64, and an upper circular coupling 62b is generated and is rotatably coupled to the flexible tension member support 28. Therefore, the upper circular coupling 62b is slidably and frictionally clamped to the flexible tension member support 28 to facilitation rotation of the leg 30a relative to the flexible tension member support 28.

A pair of guide lock panels 66 can be secured to the flexible tension member support 28, and can each comprise lower and upper pin recesses 68 and 70. A pair of support panels 72 can be secured to the lower clamp portion 60b and can support a slidable lock pin 74. The slidable lock pin 74 can be movably coupled to the support panels 72 via slots (not labeled), and biased in place by a spring(s) 76 coupled to the lock pin 74 on one end of the spring(s) 76 and to the support panels 72 on the other end. Thus, the spring(s) 76 bias the lock pin 74 inwardly towards the flexible tension member support 28 to properly seat the lock pin 74 into the lower pin recesses 68.

Therefore, to move the leg 30a from the operational configuration A to the storage configuration B, the user can pull on the slidable lock pin 74 to release the lock pin 74 from being locked into the lower pin recesses 68, then the user can rotate the leg 30a upwardly and relative to the flexible tension member support 28. During full rotation (e.g., approximately 90 degrees), the (user pulled) lock pin 74 is guided along radial edges of the guide lock panels 66, and then automatically locks into place into the upper pin recesses 70 due to the pulling force on the lock pin 74 via the spring(s) 76.

With continued reference to FIGS. 5A, 5D, and 5E, the left and right legs 30a and 30b can be rotatably moved (and locked) into their folded/storage positions via respective rotational lock couplings 56a and 56b. Each leg 30a-c can comprise a locking base member 76a-c that vertically supports the support structure 12 when on the ground surface. Notably, when the left and right legs 30a and 30b are fully rotated into their folded/storage positions, their locking base members 76a and 76b can snap into place to portions of the upper support frame 24. For instance, the base members 76a-c can have rounded interface portions (not shown in detail) sized to interface with round bars of the upper support frame 24 such that a few pounds of force can lock or unlock the legs 30a-c from respective round bar interface portions of the upper support frame 24.

Once the left and right legs 30a and 30b are locked into place (FIG. 5A), the lower extremity support member 48 can be rotated inwardly toward the folded legs 30a and 30b (as illustrated by the associated arrow). Then, the rear leg 30c can similarly be unlocked via the rotational lock couplings 56c, rotated towards legs 30a and 30b, and then snapped into place about its base member 76c. The final storage configuration is shown on FIGS. 5D and 5E, showing a low-profile folded support structure 12 for storage and transport.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A spinal traction device, comprising:
a harness including a waist support panel which is securable to a user proximate the user's hips;
first and second flexible tension members coupled to the harness; and
a support structure including stabilization legs and an upper support frame which supports the first and second flexible tension members at a predetermined support height and further includes a harness height adjustment mechanism,
wherein the first flexible tension member extends from the harness on a left side of the user, the second flexible tension member extends from the harness on a right side of the user, and the first and second flexible tension members are supported by the support structure at a spaced horizontal distance from one another, such that the harness height adjustment mechanism facilitates movement of the user's hips above the user's upper body such that at least a portion of the user's upper body weight serves to traction at least a portion of the user's spine.

2. The spinal traction device of claim 1, further comprising a lower extremity support member extending below and supported by the support structure, the lower extremity support member including a calf support platform.

3. The spinal traction device of claim 2, wherein the lower extremity support member is movable relative to the upper support frame.

4. The spinal traction device of claim 3, wherein the upper support frame comprises a horizontally extending rail, and the lower extremity support member is movable along the rail.

5. The spinal traction device of claim 2, wherein the calf support platform comprises a left calf rest and a right calf rest which support left and right calves of the user, respectively.

6. The spinal traction device of claim 5, wherein the left and right calf rests are rotatable relative to the support structure to accommodate an orientation of the lower extremity.

7. The spinal traction device of claim 1, wherein the stabilization legs comprise at least three legs in support of the upper support frame.

8. The spinal traction device of claim 1, wherein the harness height adjustment mechanism includes a user manipulable adjustment.

9. The spinal traction device of claim 1, wherein the harness height adjustment mechanism comprises a flexible tension member support configured to interface with the first and second flexible tension members and facilitate movement of the first and second flexible tension members relative to the flexible tension member support to cause a vertical position of the harness to change thereby adjusting the traction of the user's spine.

10. The spinal traction device of claim 9, wherein the stabilization legs comprise first and second legs extending from the flexible tension member support and configured to be located on left and right sides of the user, respectively.

11. The spinal traction device of claim 10, wherein the harness height adjustment mechanism further comprises first and second movable anchors associated with and movable relative to the first and second legs, respectively, wherein the first and second movable anchors are coupled to ends of the first and second flexible tension members, respectively, such that movement of the first and second movable anchors causes a vertical position of the harness to change thereby adjusting the traction of the user's spine.

12. The spinal traction device of claim 11, wherein the harness height adjustment mechanism further comprises a locking mechanism associated with each of the first and second movable anchors to facilitate selectively locking and releasing the first and second movable anchors.

13. The spinal traction device of claim 12, wherein the locking mechanism comprises a plurality of teeth and a pawl configured to engage the teeth.

14. A spinal traction device, comprising:
a support structure;
a harness configured to be secured to a user proximate the user's hips;
a flexible tension member coupled to the support structure and the harness, such that the user's hips are supported above the user's upper body and at least a portion of the user's upper body weight serves to traction at least a portion of the user's spine; and
a lower extremity support member supported by the support structure for supporting a lower extremity of the user, wherein the lower extremity support member is translatable relative to the support structure to facilitate positioning the lower extremity support member relative to the user.

15. The spinal traction device of claim 14, wherein the flexible tension member is adjustable by the user to cause a vertical position of the harness to change thereby adjusting the traction of the user's spine.

16. The spinal traction device of claim 15, wherein the support structure comprises a flexible tension member support and stabilization legs extending from the flexible tension member support, wherein the flexible tension member support is configured to support the flexible tension member.

17. The spinal traction device of claim 16, wherein at least one of the stabilization legs comprises a movable anchor associated with and movable relative to the stabilization leg, wherein the movable anchor is coupled to an end of the flexible tension member, such that movement of the movable anchor causes a vertical position of the harness to change thereby adjusting the traction of the user's spine.

18. A spinal traction device, comprising:
a harness configured to be secured to a user proximate the user's hips;
a flexible tension member coupled to the harness; and
a support structure configured to support the flexible tension member such that the user's hips are supported above the user's upper body and at least a portion of the user's upper body weight serves to traction at least a portion of the user's spine, the support structure having
a flexible tension member support configured to interface with the flexible tension member and facilitate movement of the flexible tension member relative to the flexible tension member support,
a leg extending from the flexible tension member support, and
a movable anchor associated with and movable relative to the leg,
wherein the movable anchor is coupled to an end of the flexible tension member, such that movement of the movable anchor causes a vertical position of the harness to change thereby adjusting the traction of the spine.
